(19) United States
(12) Patent Application Publication
(10) Pub. No.: US 2007/0241269 A1
(43) Pub. Date: Oct. 18, 2007

(54) Optical encoders having improved resolution

(76) Inventor: Saiful Bahari Saidan, (US)

Correspondence Address: Kathy Manke;Avago Technologies Limited, 4380 Ziegler Road, Fort Collins, CO, 80525, US

(21) Appl. No.: 11/403,944

(22) Filed: Apr. 14, 2006

(51) Int. Cl. G01D 5/34

(52) U.S. Cl. 250/231.13

(57) ABSTRACT

An improved optical encoding apparatus for the detection of position and/or motion of a mechanical device includes a codescale having an alternating pattern of windows and bars, the windows and bars having a substantially equal width, an encoder housing having one or more portions, a light-emitting source embedded within the encoder housing, a light-detecting sensor embedded within the encoder housing, the light-detecting sensor having at least six light-detecting elements, wherein the encoder housing includes one or more optical elements configured to enable light generated by the light-emitting source to project the codescale's pattern of bars and windows onto the light-detecting sensor, and wherein the width of each light-detecting element is no more than ⅓ the width of the windows and bars projected onto the light-sensing detector.

### BACKGROUND

The present invention relates to an optical encoding device for the sensing of position and/or motion.

Optical encoders are used in a wide variety of contexts to determine position and/or movement of an object with respect to some reference. Optical encoding is often used in mechanical systems as an inexpensive and reliable way to measure and track motion among moving components. For instance, printers, scanners, photocopiers, fax machines, plotters, and other imaging systems often use optical encoders to track the movement of an image media, such as paper, as an image is printed on the media or an image is scanned from the media

Generally, an optical encoder includes some form of light emitter/detector pair working in tandem with a “codewheel” or a “codestrip”. Codewheels are generally circular and can be used for detecting rotational motion, such as the motion of a paper feeder drum in a printer or a copy machine. In contrast, codestrips generally take a linear form and can be used for detecting linear motion, such as the position and velocity of a print head of the printer. Such codewheels and codestrips generally incorporate a regular pattern of slots and bars depending on the form of optical encoder.

While optical encoders have proved to be a reliable technology, there still exists substantial industry pressure to simplify manufacturing operations and decrease costs while improve spatial resolution and other performance issues. Accordingly, new technology related to optical encoders is desirable.

### SUMMARY

In a first sense, an optical encoding apparatus for the detection of position and/or motion of a mechanical device includes a codescale having an alternating pattern of windows and bars, the windows and bars having a substantially equal width, an encoder housing having one or more portions, a light-emitting source embedded within the encoder housing, a light-detecting sensor embedded within the encoder housing, the light-detecting sensor having at least six light-detecting elements, wherein the encoder housing includes one or more optical elements configured to enable light generated by the light-emitting source to project the codescale's pattern of bars and windows onto the light-detecting sensor, and wherein the width of each light-detecting element is no more than ⅓ the width of the windows and bars projected onto the light-sensing detector.

In a second sense, an optical encoding apparatus for the detection of position and/or motion includes a codescale having an alternating pattern of windows and bars, the windows and bars having a substantially equal width, an encoder housing having one or more portions, a light-emitting source embedded within the encoder housing, a light-sensing means embedded within the encoder housing for use in the detection of codescale travel; and one or more optical elements configured to enable light generated by the light-emitting source to project the codescale's pattern of bars and windows onto the light-sensing means.

In a third sense, a method for detecting both a distance and direction traveled for a codescale in an optical encoding apparatus includes projecting a first pattern of windows and bars from the codescale onto a light-sensing detector having at least six light-detection elements, the projected windows and bars each having a first width and the light-detection elements each having a second width, the second width being less than ⅓ the first width, sampling the state of each light-detection element a first time, moving the codescale at least one second width, projecting a second pattern of windows and bars from the codescale onto the light-sensing detector, sampling the state of each light-detection element a second time and determining at least the direction of codescale travel using the sensed states of the first and second samplings.

### DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 shows a first reflection-based optical encoder;

FIG. 2 shows a first conventional optical detector;

FIG. 3 shows a second conventional optical detector;

FIG. 4 shows a third conventional optical detector; and

FIG. 5 shows an improved optical detector for use with the disclosed methods and systems.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

In the following embodiments, the novel systems and apparatus of the present disclosure can improve the spatial resolution of optical encoders over previously known devices. By incorporating detectors that use a high number of detection elements for a given distance as compared to the distance of a window and bar of a respective codescale, spatial resolution can be increased with a minimum of expense.

Optical encoders are generally classified into two categories: transmission-based optical encoders and reflection-based optical encoders. The following disclosure is generally directed to reflection-based optical encoders. However, it should be appreciated that many of the various system, devices and processes described herein can apply to transmission-based encoders as well.

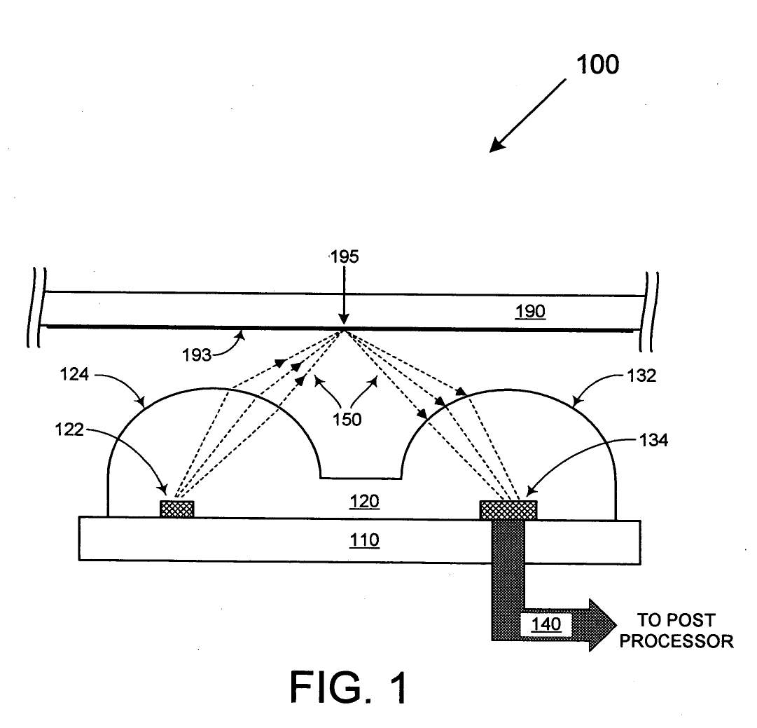

FIG. 1 shows a first reflection-based optical encoder 100. The reflection-based encoder 100 includes an optical emitter 122 and an optical detector 132 mounted on a substrate 110 and encapsulated in an optical housing 120, which is typically made from some form of resin or glass. The exemplary optical housing 120 has two dome-shaped lenses 124 and 134, with the first lens 124 directly above the optical emitter 122 and the second lens 134 directly above the optical detector 132. A codescale 193, i.e., a codewheel, codestrip or the like, is positioned above the housing 120 on body 190, which for the present example can be a flat, linearly moving body or spinning disk. A link 140 is provided from the detector 134 to a post processor (not shown) in order that light signals reaching the detector 134 can be properly interpreted.

In operation, light emitted by the optical emitter 122 can be focused by the first lens 124, then transmitted to the codescale 193 along the light's path 150 at location 195. Should the codescale 193 be positioned such that a reflective slot/bar is present at location 195, the transmitted light can be reflected to the second lens 134, then focused by the second lens 134 onto the optical detector 132 where it can be detected. Should the codescale 193 be positioned such that a reflective slot/bar is not present at location 195, the transmitted light will be effectively blocked, and the optical detector 132 can detect the absence of light. Should the codescale 193 be configured and position such that a combination of reflective and non-reflective bars are simultaneously present at location 195, the codescale 193 can reflect light commensurate with the pattern of reflective and non-reflective bars such that the pattern is effectively projected onto the optical detector 132.

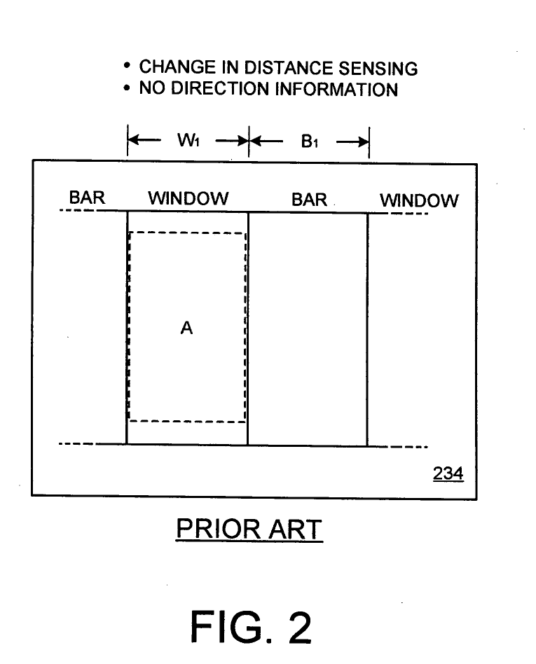

Generally, it should be appreciated that conventional optical encoders use either single-element detectors or detectors having a low number of optical detection elements. By way of example, FIG. 2 shows such a first conventional detector 234 for use in an optical encoder, such as the encoder 100 of FIG. 1. As shown in FIG. 2, the optical encoder 234 has a single optical detection element {A} having a width W₁ and being capable of producing two discrete states: 0 and 1. A projected codescale pattern having alternating windows and bars is superimposed over the optical detector 234. Assuming that the width of the windows W₁ and the bars B₁ is approximately equal, a moving codescale producing the projected codescale pattern can cause the detection element {A} to produce an alternating 1-0-1-0-1-0 output. While the detector 234 of FIG. 2 can be used to sense a change in codescale position to a resolution of W₁, the detector 234 cannot be used to sense the direction of codescale travel.

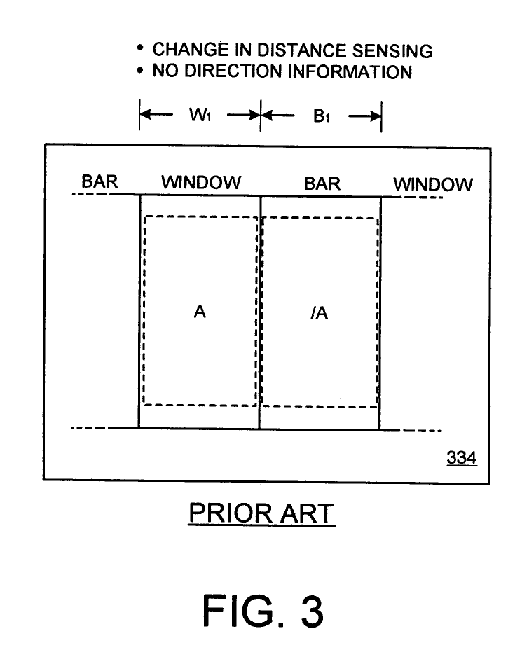

FIG. 3 shows a second conventional detector 334 that can be used with optical encoders. As shown on FIG. 3, the detector 334 has two light-detecting elements {A, /A}. Given the series of windows and bars shown superimposed over the light-sensing elements {A, /A}, the states produced by detection elements {A, /A} can alternate between {1, 0} and {0, 1} for every interval W₁ traveled by the codescale. Although the second detector 334 shares a limitation with the detector 234 of FIG. 2 in that it cannot be used to detect the direction of codescale travel, the detector 334 has an advantage in that it can provide a differential output and thus improve the signal-to-noise ratio of an optical detection system

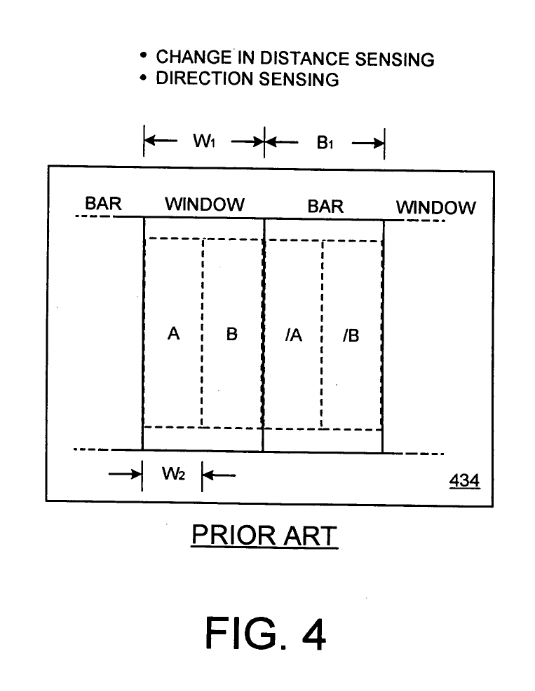

Continuing to FIG. 4, a detector 434 is shown that can be used to detect the direction that a codescale travels as well as a distance traveled. This directional sensing advantage can be gained by increasing the number of detection elements to four with each detection element having a width half that of the codescale's projected bars and windows. As shown in FIG. 4, the optical detector 434 has four detection elements {A, B, /A, /B}, which can produce a set of four distinct states: {1, 1, 0, 0} {0, 1, 1, 0} {0, 0, 1, 1} and {1, 0, 0, 1}. Assuming that the detection elements {A, B, /A, /B} each have a width W₂, (W₂ being half the width of W₁), the detector 434 can not only sense the direction of travel for a codescale, but it can sense a distance of codescale travel to a resolution W₂, which is twice the distance resolution available to that of the previously described detectors 234 and 334 of FIGS. 2 and 3.

Keeping FIG. 4 in mind, it should be appreciated that a conventional approach to increasing resolution for optical encoders while maintaining direction sensing capacity would be to continue using the four-element architecture while incorporating finer geometries in both detection elements and codescales.

However, as will be demonstrated below, the inventor of the disclosed methods and systems has devised a different approach to optical encoders where the cost tradeoffs differ substantially from conventional approaches.

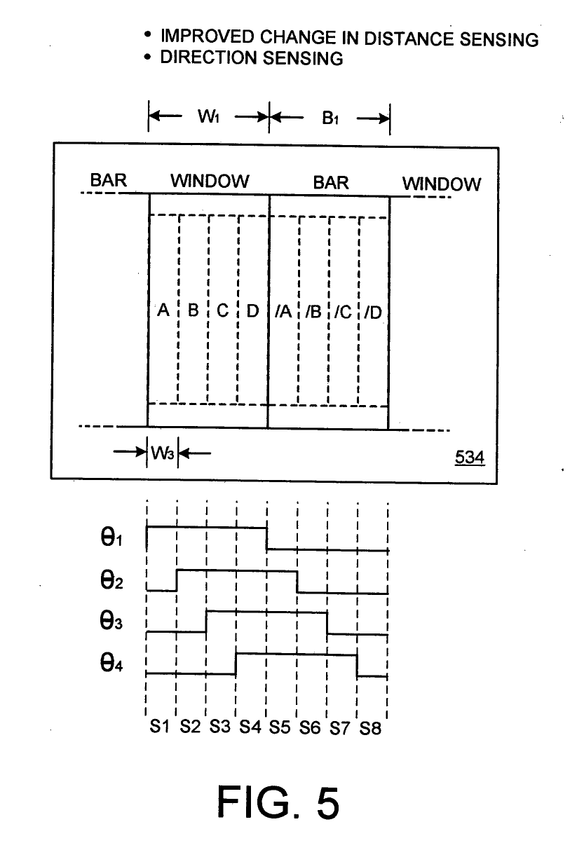

FIG. 5 shows an improved optical detector 534 that can be used with optical encoders, such as the encoder 100 of FIG. 1. As shown in FIG. 5, the improved optical detector 532 includes eight separate detection elements {A, B, C, D, /A, /B, /C, /D}, which is far more than the four detections element required to sense both distance and direction traveled. The output states for the detection elements {A, B, C, D, /A, /B, /C, /D are: {1,1,1,1,0,0,0,0}, {0,1,1,1,1,0,0,0}, {0,0,1,1,1,1,0,0}, {0,0,0,1,1,1,1,0}, {0,0,0,0,1,1,1,1}, {1,0,0,0,0,1,1,1}, {1,1,0,0,0,0,1,1} and {1,1,1,0,0,0,0,1}. The improved resolution can be attributed at least in part to the width of each detection element W₃, which is one-fourth the width W₁ of the windows and bars of the previously discussed codescale pattern.

While the exemplary detector 534 has eight detection elements of width W₃ (=W₁/4), it should be appreciated the concepts of FIG. 5 can extend to detectors having other numbers of detection elements. For example, a detector with six detection elements with each element having a width of W₁/3 can be used. Similarly, a detector with ten detection elements with each element having a width of W₁/5 also can be used, and so on.

Returning to FIG. 5, while the conventional approach to making a detection device with finer resolution might be a matter of merely shrinking the geometries of the detector 434 of FIG. 4, the inventor of the improved optical detector 134 has created a device that can provide finer spatial resolution using relatively coarser resolution codescale. Accordingly, any expenses incurred due to the increased number of detection elements can be offset by: (1) a manufacturing advantage in that existing codescales can be used, (2) a manufacturing advantage in that retooling a production line to produce different codescales might be avoided and (3) that new manufacturing problems arising due to the finer resolution issues will not be incurred. For example, a codewheel for a transmission-type optical encoder can avoid the various manufacturing flaws that might arise by doubling the number of windows and bars using conventional approaches.

Again returning to FIG. 5, while the exemplary detector 134 of FIG. 5 can detect discrete 0/1 states for each detector, it should be appreciated that further resolution might be gained from the present detector 534 by taking advantage of the analog (and presumably linear or somewhat linear) transfer function of the individual detection elements {A, B, C, D, /A, /B, /C or /D}. That is, by sampling each detection element output using an analog-to-digital converter and then applying optionally some linearization algorithm to the digitized data, distance resolution can be extended to a distance substantially less that W₃.

While example embodiments are disclosed herein, one of ordinary skill in the art appreciates that many variations that are in accordance with the present teachings are possible and remain within the scope of the appended claims. The embodiments therefore are not to be restricted except within the scope of the appended claims.

1. An optical encoding apparatus for the detection of position and/or motion of a mechanical device, the apparatus comprising:
a codescale having an alternating pattern of windows and bars, the windows and bars having a substantially equal width;
an encoder housing having one or more portions;
a light-emitting source embedded within the encoder housing;
a light-detecting sensor embedded within the encoder housing, the light-detecting sensor having at least six light-detecting elements;
wherein the encoder housing includes one or more optical elements configured to enable light generated by the light-emitting source to project the codescale's pattern ofbars and windows onto the light-detecting sensor; and
wherein the width of each light-detecting element is no more than ⅓ the width of the windows and bars projected onto the light-sensing detector.

2. The optical encoding apparatus of claim 1, wherein the light-detecting sensor has at least eight light-detecting elements, and wherein the width of each light-detecting element is no more than approximately ¼ the width of the windows and bars projected onto the light-sensing detector.

3. The optical encoding apparatus of claim 1, wherein the light-detecting sensor has eight light-detecting elements, and wherein the width of each light-detecting element is approximately ¼ the width of the windows and bars projected onto the light-sensing detector.

4. The optical encoding apparatus of claim 3, wherein the optical encoding apparatus further include a post processor configured to interpret signals produced by the light-detecting elements.

5. The optical encoding apparatus of claim 4, wherein the optical encoding apparatus is configured to sense both the direction of codescale travel and distance of codescale travel.

6. An optical encoding apparatus for the detection of position and/or motion of a mechanical device, the apparatus comprising:
a codescale having an alternating pattern of windows and bars, the windows and bars having a substantially equal width;
an encoder housing having one or more portions;
a light-emitting source embedded within the encoder housing;
a light-sensing means embedded within the encoder housing for use in the detection of codescale travel; and
one or more optical elements configured to enable light generated by the light-emitting source to project the codescale's pattern of bars and windows onto the light-sensing means.

7. The optical encoding apparatus of claim 6, wherein the light-sensing means includes a plurality of light-detecting elements, and wherein the width of each light-detecting element is a fraction of the width of the windows and bars projected onto the light-sensing means.

8. The optical encoding apparatus of claim 7, wherein the light-sensing means has at least eight light-detecting elements, and wherein the width of each light-detecting element is no more than approximately ¼ the width of the windows and bars projected onto the light-sensing detector.

9. The optical encoding apparatus of claim 8, wherein the light-detecting means has eight light-detecting elements, and wherein the width of each light-detecting element is approximately ¼ the width of the windows and bars projected onto the light-sensing detector.

10. The optical encoding apparatus of claim 9, wherein the optical encoding apparatus further include a post processor configured to interpret signals produced by the light-detecting elements.

11. A method for detecting both a distance and direction traveled for a codescale in an optical encoding apparatus, the method comprising:
projecting a first pattern of windows and bars from the codescale onto a light-sensing detector having at least six light-detection elements, the projected windows and bars each having a first width and the light-detection elements each having a second width, the second width being less than ⅓ the first width;
sampling the state of each light-detection element a first time;
moving the codescale at least one second width, projecting a second pattern of windows and bars from the codescale onto the light-sensing detector;
sampling the state of each light-detection element a second time; and
determining at least the direction of codescale travel using the sensed states of the first and second samplings.

12. The method of claim 11, wherein the light-sensing means has at least eight light-detecting elements, and wherein the width of each light-detecting element is no more than approximately ¼ the width of the windows and bars projected onto the light-sensing detector.

13. The optical encoding apparatus of claim 12, wherein the light-detecting means has eight light-detecting elements, and wherein the width of each light-detecting element is approximately ¼ the width of the windows and bars projected onto the light-sensing detector.
